(19) United States
(12) Patent Application Publication
(10) Pub. No.: US 2005/0206107 A1
(43) Pub. Date: Sep. 22, 2005

(54) Medical device carrier with a docking station

(76) Inventors: Werner Schubert, Weissenberg (DE); Rudolf Marka, Munich (DE); Peter Mueller, Grosshelfendorf (DE)

Correspondence Address: FISH & RICHARDSON PC, P.O. BOX 1022, MINNEAPOLIS, MN, 55440-1022, US

(21) Appl. No.: 11/077,379

(22) Filed: Mar. 11, 2005

(30) Foreign Application Priority Data
Mar. 12, 2004 (EP) 04 006 002.2

(51) Int. Cl. B62B 5/00; B62B 1/00

(52) U.S. Cl. 280/79.11

(57) ABSTRACT

A mobile medical equipment cart with a docking device for docking against a side or end face of a hospital bed includes an arm having a receptacle adapted to engage a feature of a hospital bed and a spring biasing the arm against the received feature of the hospital bed against which the cart is docked, thereby securing the cart to the bed.

### CLAIM OF PRIORITY

This application claims priority under 35 USC § 119(a) to European Patent application number 04 006 002.2, filed on Mar. 12, 2004, the entire contents of which are hereby incorporated by reference.

### TECHNICAL FIELD

This disclosure relates to a mobile medical equipment cart, more particularly, to a device for docking a mobile medical equipment cart to a hospital bed.

### BACKGROUND

In many cases, patients in a hospital's intensive care unit must be connected to medical equipment or receive infusions. The equipment required to this end generally is stored on an equipment rack that is, for example, coupled to a wall-mounted or ceiling-mounted stand. In order to continue the patient care while the patient is transported (e.g., while the patient is transported inside the hospital) the equipment is transferred from the wall-mounted or ceiling-mounted stand to a mobile equipment cart that is coupled to a hospital bed and, along with the bed, moved to the desired location.

An apparatus for connecting a mobile medical equipment cart to a hospital bed in a detachable manner is disclosed in DE 40 48 427 A1. The mobile medical equipment cart includes a basic structure with a vertical rack assembly provided with a vertically adjustable equipment rack shelf. Adjustable retaining claws are arranged on the equipment rack, wherein hooks that are open towards the bottom are inserted in the retaining claws, and the hooks ensure fast connection and disconnection of the mobile medical equipment cart by hanging in and unhinging from hospital beds of various constructions. The usability of such a hook construction, however, cannot be applied universally to any type of bed, because there are innumerable types of beds possessing different types of rails and dimensions, into which the hooks must be hung, with the result that the suitable hooks must each time be provided specifically therefore.

For that reason, a docking device of a mobile medical equipment cart, which permits universal utilization for nearly every hospital bed and which ensures a reliable, easy and fast connection of the equipment cart to the hospital bed is desirable.

### SUMMARY

In a general aspect, a mobile medical equipment cart with a docking device for docking against a side or end face of a hospital bed includes an arm having a receptacle adapted to engage a feature of a hospital bed and a spring biasing the arm against the received feature of the hospital bed against which the cart is docked, thereby securing the cart to the bed.

In another general aspect, a mobile medical equipment cart includes a wheeled base, an arm of adjustable length and adapted to releasably couple the cart across a side or end face of a hospital bed for transport therewith, and a spring arranged to bias the arm either vertically or in a direction along its length to hold the cart in a position securely attached to the hospital bed until released.

Implementations can include one or more of the following features. For example, the arm can include two receptacles disposed at opposite ends of the arm and adapted to engage spaced apart features of the hospital bed. The receptacles can be adapted for positive engagement with collision protection devices of the hospital bed. The receptacles can include a substantially circular plate with a wedge missing from the substantially circular plate and a rim connected to the plate, the rim having a shape that forms a portion of a circle that is adapted for receiving at least one of the members of the hospital bed.

The arm can have an adjustable unloaded length. The spring can bias the arm in a horizontal direction parallel to a surface of the bed or in a vertical direction perpendicular to a surface of the bed, and the spring can be a pneumatic spring. The arm can include a handle or foot lever coupled to the arm and operable to displace the arm in a direction opposing a bias force applied by the spring.

In a further general aspect, the a hospital bed is coupled to a mobile medical equipment cart that includes a wheeled base, an arm of adjustable length releasably coupled to the cart across a side or end face of the hospital bed, and a spring that biases the arm either vertically or in a direction along its length to hold the cart in a position securely attached to the hospital bed until released.

The details of one or more implementations are set forth in the accompanying drawings and the description below. Other features and advantages will be apparent from the description and drawings, and from the claims.

### DESCRIPTION OF DRAWINGS

FIG. 1 is a schematic perspective view of a mobile equipment cart and a hospital bed.

FIG. 2 is a schematic side view of a mobile medical equipment cart in its home position.

FIG. 3 is a schematic side view of the medical equipment cart before a docking process occurs.

FIG. 4 is a schematic side view of the medical equipment cart after the docking process has occurred.

FIG. 5 is a schematic top view of the medical equipment cart in its docked position.

FIG. 6 is a schematic perspective view of a docking device.

FIG. 7 is a schematic perspective view of the docking device of FIG. 6 in its assembled state, together with a part of the equipment cart.

FIG. 8 is a top view of the docking device of FIG. 7.

Like reference symbols in the various drawings indicate like elements.

### DETAILED DESCRIPTION

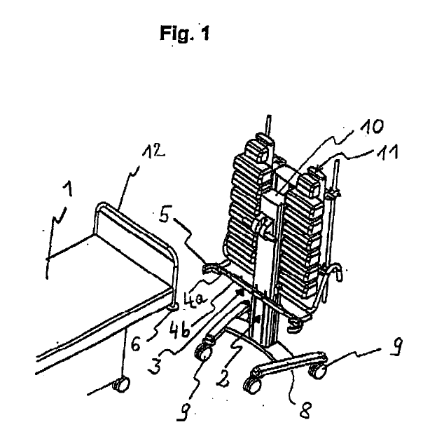

FIG. 1 shows a part of a hospital bed 1 and a mobile medical equipment cart 2. The equipment cart 2 includes a carriage 8 having four wheels 9. A vertical column 10 is attached to the carriage 8. A pump rod carrier 11 is coupled to the column 10 on the carriage 8 and can receive medical equipment, for example, medical infusion pumps. In its longitudinal direction, the hospital bed 1 includes a termination plate or a rail 12 that can be, for example, grasped to push the bed aside. At its lower ends, and on each its sides, the rail 12 is provided with collision protection devices 6 that can be in the form of plate-shaped components made of hard rubber or plastic.

As shown in FIG. 6, the docking device 3 includes an arm 4 in the form of a horizontally extending rod. A receptacle 5 is provided at each end of the arm 4, and the receptacle 5 can have a shape of a plate with a wedge of approximately a quarter of a circle being cut out from the plate. A vertically extending rim 5a is provided on the perimeter of the receptacle 5. The arm 4 includes a length adjustable structure. For example, the arm 4 can include, on each side, two relatively long elements that are displaceable inside each other. Thus, an inner rod 4a and an outer rod 4b that can be dimensioned such that the inner rod 4a can be retracted into and extracted out of the outer rod 4b. The same structure is also provided on the other side of the arm 4. A locking device 13 can fix the longitudinal position of the arm 4. The locking device 13 can include an elongated hole in each rod 4a and 4b and a screw that is passed through the two elongated holes and is then screwed into a nut (e.g., a wing nut). This configuration allows adjustment of the arm 4 to match any arbitrary width of a hospital bed 1. A guide element 14 that extends in an upward direction can be attached centrally to the arm 4. The guide element 14 can have a C-shaped cross-section and can include a base plate 14a and two short sides 15. At their upper and lower ends, the sides 15 each can be provided with rollers 16 that are mounted in bearings and the axes of which extend parallel to the base plate 14a. At its upper and lower ends, the base plate 14a is likewise provided with rollers 17 that are also mounted in bearings but the axes of which extend parallel to the short sides 15.

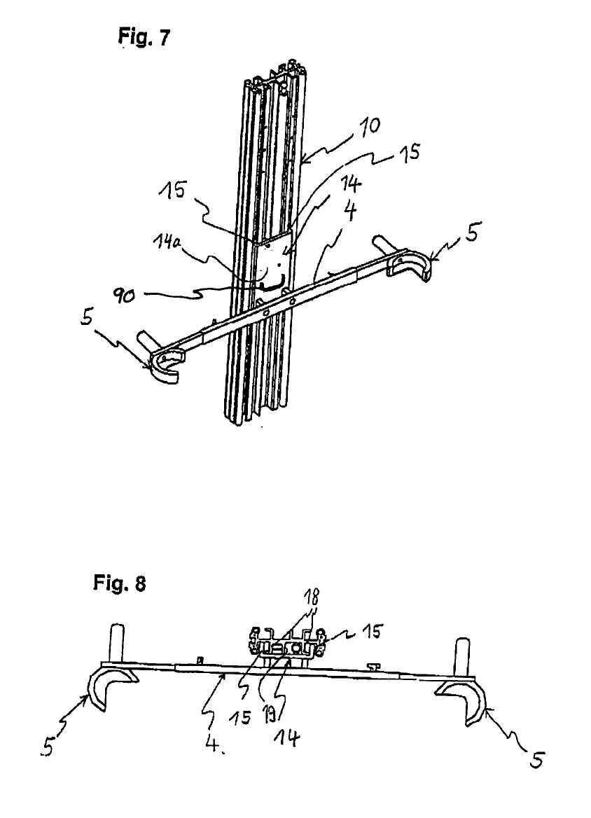

As shown in FIGS. 7 and 8, the guide element 14 is supported by the column 10 in a slidable manner and is guided by the rollers 16 and 17. The cross-section of the column 10 can be seen in FIG. 8. Thus, the cross-sectional profile of the column 10 is approximately I-shaped. In addition, several ribs 18 can extend at right angles from the longitudinal section of the I-profile of the column 10. As shown in FIG. 8, the guide element 14 can encompass the rectangular ribs 18 with its sides 15, so that the rollers 15 roll along the side of the column 10. Furthermore, straight ribs 19 are provided on that side of the column 10 along which the rollers 17 roll, which accomplishes a stable and accurate guiding of the arm 4 along the column 10.

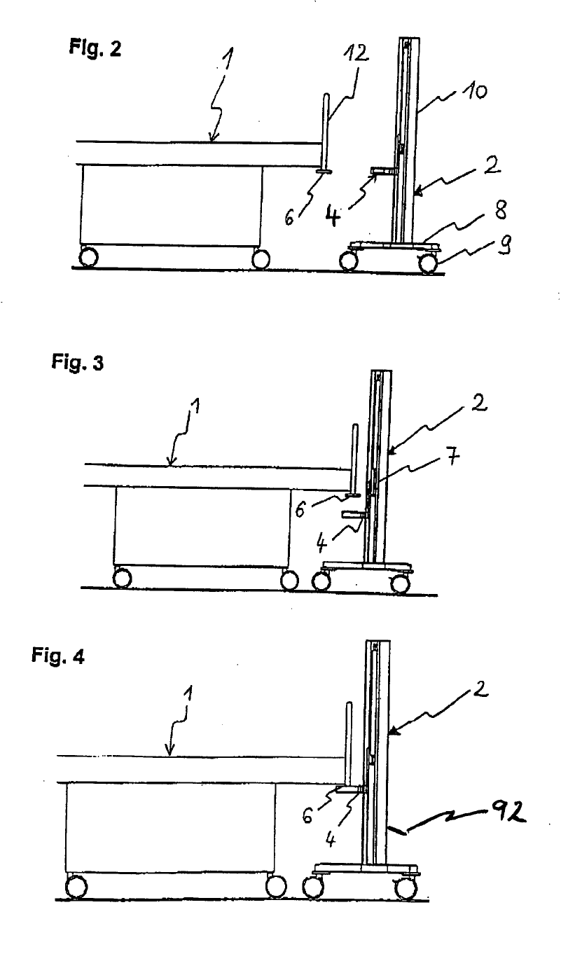

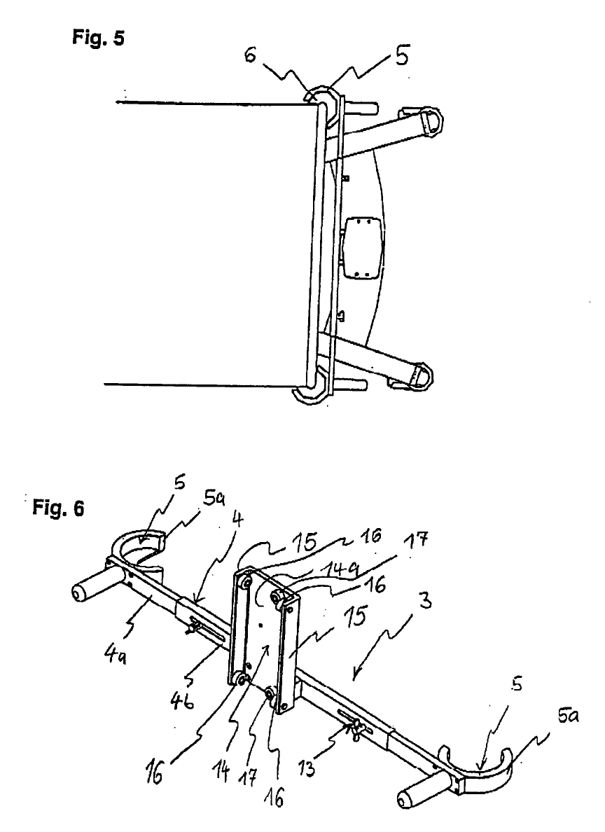

FIG. 2 shows the equipment cart 2 with its arm 4 in the home position in which the arm is pressed upwards by the biasing of an energy storing device, for example, a pneumatic spring 88. The topmost position of the arm is above the uppermost level of the collision protection device 6, thus ensuring that when the bed is passing over an obstacle the receptacles 5 remain in positive engagement with the collision protection devices 6.

By providing an energy storage device, for example, in the form of a pneumatic spring, for providing the biasing of the arm, space requirements are reduced because a pneumatic spring relatively less free space, while ensuring permanently reliable operation of the docking device. The energy storage device can bias the arm against the collision protection device or other parts of the bed (e.g., termination plates, rails or bed frames) by biasing the arm against that portion of the bed that is engaged by the receptacles 5 of the arm.

As shown in FIG. 3, the equipment cart 2 is directly in the position of docking to the hospital bed 1. In this position, the arm 4 is pressed down against the biasing force of the pneumatic spring.

Thereafter, the arm 4 is released, such that the biasing force of the pneumatic spring moves the arm 4 upwards in the direction to the collision protection device 6 until the receptacles 5 positively engage the collision protection devices 6, as depicted in FIG. 4.

As shown in FIGS. 7 and 8, the receptacle 5 have the shape of a plate, with a wedge of approximately a quarter of a circle being cut out of the plate. This configuration facilitates engagement of the receptacles 5 with the collision protection devices 6. The positive engagement and the encompassing of the collision protection device 6 with the rim 5a having the shape of a three-quarter circle ensures that the equipment cart 2 is securely connected to the hospital bed 1. This allows movement of the interlocked combination of hospital bed 1 and equipment cart 2, wherein the equipment cart 2 can both be pushed while pressing against the hospital bed 1 and pulled while pulling the hospital bed along.

The biasing of the arm 4 in an upward direction by means of the pneumatic spring ensures a secure connection between the arm 4 and the collision protection devices 6 even if the hospital bed 1 is adjusted in height after engagement with the arm 4 or if the hospital bed 1 or the equipment cart 2 is passed over thresholds or the like, because the docking device 3 is always pressed upwards by the force of the spring, and the receptacles 5 reliably enclose the collision protection devices 6.

Decoupling of the arm 4 from the collision protection devices 6 can be achieved in an easy and simple manner by manually moving the arm 4 down and removing the equipment cart 2 or the hospital bed 1.

In an alternative implementation, the arm 4 is designed such that it is attached to the cart 2 in a vertically movable manner only inasmuch as it can follow the lifting movements of the bed 1 and can allow a vertical movement of the cart 2 relative to the bed 1 while it is passed over thresholds or obstacles. A home position allowing a movement of the arm 4 both in upward and downward directions can be accomplished by using springs to hold the arm 4. In the alternative implementation, the arm 4 can be variable in its length and can be biased, for example, by a compression spring or an extension spring, such that the receptacles 5 provided at each end of the arm are pressed in a direction in which they are moved towards each other. In this case, the receptacles 5 can be designed such that they engage and fix the collision protection devices 6 or other parts of the bed 1, when in their docked position, from the side.

In an alternative implementation, the movable arm 4 can include a handle 90 (shown in FIG. 7) or a foot lever 92 (shown in FIG. 4) with which the docking device 3 can be handled to move the docking device 3 in an opposite direction to the biasing force from the energy storage device before engaging the docking device 3 with the hospital bed 1. Once the docking device is in the proper position in which the receptacles 5 are located below or above or to the side of the collision protection devices 6 or to the side of other parts of the bed, the handle or foot lever can be released to cause the arm 4 to move automatically in the direction to the collision protection device 6 or the part of the bed to be engaged by the arm and initiating a docking process.

### OTHER IMPLEMENTATIONS

A number of implementations have been described. Nevertheless, it will be understood that various modifications may be made. Accordingly, other implementations are within the scope of the following claims.

1. A mobile medical equipment cart with a docking device for docking against a side or end face of a hospital bed, the docking device comprising:
an arm having a receptacle adapted to engage a feature of a hospital bed; and
a spring biasing the arm against the received feature of the hospital bed against which the cart is docked, thereby securing the cart to the bed.

2. The mobile medical equipment cart to claim 1, wherein the arm comprises two receptacles disposed at opposite ends of the arm and adapted to engage spaced apart features of the hospital bed.

3. The mobile medical equipment cart of claim 2, wherein the receptacles are adapted for positive engagement with collision protection devices of the hospital bed.

4. The mobile medical equipment cart of claim 2, wherein the receptacles comprise:
a substantially circular plate with a wedge missing from the substantially circular plate; and
a rim connected to the plate, the rim having a shape that forms a portion of a circle that is adapted for receiving at least one of the members of the hospital bed.

5. The mobile medical equipment cart of claim 1, wherein the arm has an adjustable unloaded length.

6. The mobile medical equipment cart of claim 5, wherein the spring biases the arm in a horizontal direction parallel to a surface of the bed.

7. The mobile medical equipment cart of claim 2, wherein the spring biases at the arm in a vertical direction perpendicular to a surface of the bed.

8. The mobile medical equipment cart of claim 1, wherein the spring comprises a pneumatic spring.

9. The mobile medical equipment cart of claim 1, wherein the arm comprises a handle or foot lever coupled to the arm and operable to displace the arm in a direction opposing a bias force applied by the spring.

10. A mobile medical equipment cart comprising:
a wheeled base;
an arm of adjustable length and adapted to releasably couple the cart across a side or end face of a hospital bed for transport therewith; and
a spring arranged to bias the arm either vertically or in a direction along its length to hold the cart in a position securely attached to the hospital bed until released.

11. The mobile medical equipment cart to claim 10, wherein the arm comprises two receptacles disposed at opposite ends of the arm and adapted to couple to spaced apart members of the hospital bed.

12. The mobile medical equipment cart of claim 11, wherein the receptacles comprise:
a substantially circular plate with a wedge missing from the substantially circular plate; and
a rim connected to the plate, the rim having a shape that forms a portion of a circle that is adapted for receiving at least one of the members of the hospital bed.

13. The mobile medical equipment cart of claim 10, wherein the arm is of an adjustable unloaded length.

14. The mobile medical equipment cart of claim 13, wherein the spring biases the arm in a horizontal direction parallel to a surface of the bed.

15. The mobile medical equipment cart of claim 11, wherein the spring biases at the arm in a vertical direction perpendicular to a surface of the bed.

16. The mobile medical equipment cart of claim 10, wherein the spring comprises a pneumatic spring.

17. The mobile medical equipment cart of claim 10, wherein the arm comprises a handle or foot lever coupled to the arm and operable to displace the arm in a direction opposing a bias force applied by the spring.

18. In combination,
a hospital bed; and
the mobile medical equipment cart of claim 10 releasably coupled to the bed.
